(19) United States
(12) Patent Application Publication
(10) Pub. No.: US 2008/0196309 A1
(43) Pub. Date: Aug. 21, 2008

(54) Door That Converts Into A Staircase For Accessing A Machine Tool And Machine Tool Equipped With Such A Door

(75) Inventors: Jacques Thibaut, Vaudry (FR); Christophe Thibaut, Vire (FR)

Correspondence Address: EGBERT LAW OFFICES, 412 MAIN STREET, 7TH FLOOR, HOUSTON, TX, 77002, US

(73) Assignee: THIBAUT, Vire (FR)

(21) Appl. No.: 11/997,392

(22) PCT Filed: Jul. 12, 2006
(86) PCT No.: PCT/FR06/01735

§ 371 Date: Jan. 30, 2008

(30) Foreign Application Priority Data
Aug. 4, 2005 (FR) 0508306

(51) Int. Cl. B23Q 11/08

(52) U.S. Cl. 49/37

(57) ABSTRACT

A door to a machine tool positioned at the front of the machine tool on the workstation side. The door is equipped with steps along an entire length thereof to provide access to the workstation of the machine tool when in a folded-down position.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a door that can be converted into a staircase for accessing a machine tool, and to a machine tool equipped with such a door.

2. Description of Related Art Including Information Disclosed Under 37 CFR 1.97 and 37 CFR 1.98.

Numerically-controlled machine tools, particularly those intended for working granite and marble, force the operator to have regular access to the machine tool in order to reach the workstation during various phases in machining of a workpiece. Access to the work table may be needed in order to perform operations such as:
fitting work holding means (chiefly suction cups),
loading the workpiece,
accessing the tool magazine,
unloading the workpiece,
any interventions that might be required between two operations, and
cleaning the workstation.

Furthermore, the table heights are generally 700 millimeters off the ground, so as to optimize the working position when connecting up the work holding suction cups. However, this ergonomic height does nothing to make it easier for the operator to access the work table. The operator often has to use a pair of steps. Now, using something such as this is not always practical because of considerations of space. In addition, two operators are generally needed to unload the machined workpieces, because of their fragility and their weight, hence the need for easy, safe and retractable access to the work table.

For safety reasons, machine tools are configured in such a way that the front door thereof, that allows access to the workstation, is closed and locked when the machine tool is operating in an automatic cycle.

In certain types of machine tools, particularly numerically controlled machine tools, water used for machining is recycled, hence the need for a front door to limit splashing and loss of water.

### BRIEF SUMMARY OF THE INVENTION

The invention sets out to overcome the aforementioned disadvantages by proposing a front door to a machine tool which makes for easier access to the work table while at the same time providing the operator with an optimum level of safety and containment of water splashes.

To these ends, the subject of the present invention is a door to a machine tool, the door being positioned at the front of this machine tool on the workstation side. The present invention is equipped with steps along its entire length to provide access to the workstation of the machine tool when it is in the folded-down position and when the machine tool is not in operation.

### BRIEF DESCRIPTION OF THE SEVERAL VIEWS OF THE DRAWINGS

The invention will be better understood with reference to the attached drawings.

FIG. 1 is an upper perspective view of the machine tool equipped with the door, in the open position.

FIG. 2 is another perspective view of the machine tool equipped with the door, in the closed position.

FIG. 3 is a partial detailed perspective view of the door.

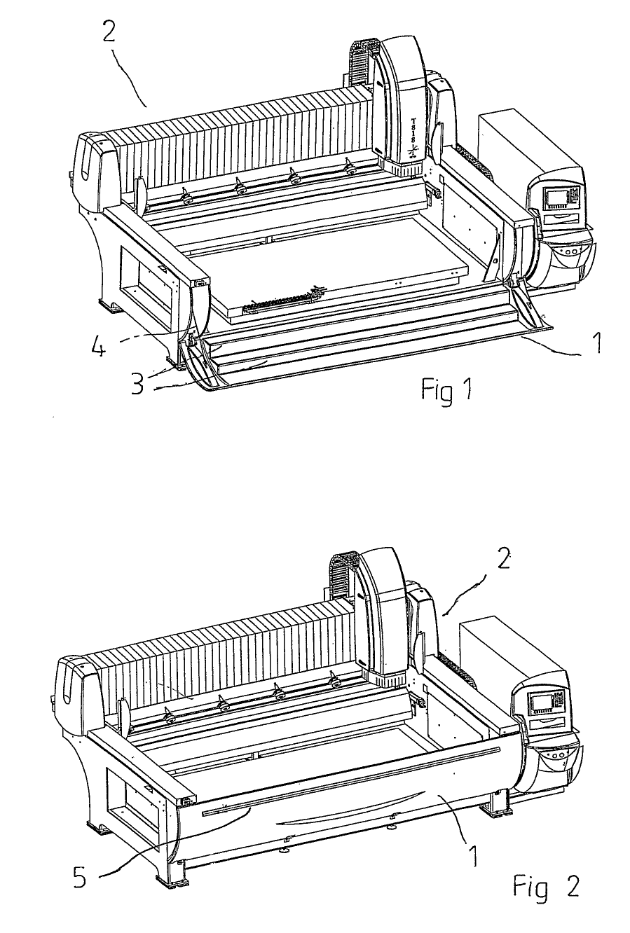

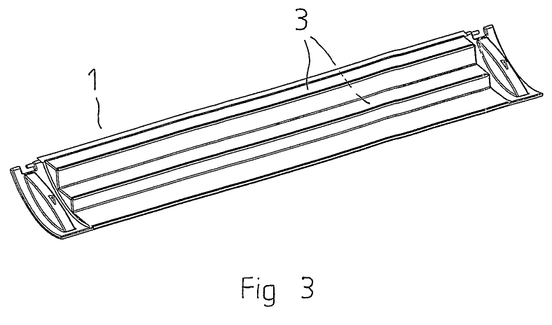

### DETAILED DESCRIPTION OF THE INVENTION

The door (1), which is made up of staircase-type steps (3), is mounted on the front of the machine tool (2) on the workstation side, so as to facilitate access thereto. It is pivotally mounted using two bearings fixed to the frame of the machine tool (2).

The opening and closing of this door are controlled by two actuators which operate a lifting cable (4) and are dependent on whether or not the machine tool (2) is in operation. The door (1) is allowed to open only when the machine tool (2) is not in operation. It is prevented from opening when the machine tool (2) is operating in an automatic cycle.

A device for monitoring the position of the actuator rods allows the machine to be stopped automatically if the door is opened during the automatic cycle, in order to ensure operator safety. The closure principle also allows the door (1) to be closed only when the steps (3) of the staircase are clear, so as to optimize operator safety and prevent any unwanted closure of the door (1) to the machine tool (2).

The steps (3) that make up the door (1) are equipped with a non-slip device so as to limit the risk that the operator will slip and fall.

The door (1) is equipped on its exterior face with a rubber strip (5) intended to form a point of contact with the ground, so as to compensate for any unevenness of the ground in front of the machine tool (2).

The door (1) is preferably made of glass-fiber-reinforced polyester which thus gives its lightness of weight, rigidity, and resistance to corrosion. Its shape will be such that it fits onto the front face of the machine tools for which it is intended.

In the open position, the door, with its steps, allows access to the workstation without cluttering the latter.

In the closed position, the door prevents access to the workstation and provides containment for any splashing that may be associated with the machining of the workpiece.

The front door according to the invention facilitates access to the work table by virtue of its steps which are built in along the entire length of the door.

Furthermore, the front door ensures operator safety when the machine tool is operating in automatic mode, insofar as access to the machine tool is prevented and the door remains closed.

The door and the steps with which it is equipped do not in any way clutter the operator's work space and even remove any obstacle in front of the workstation. The amount of clutter in front of the machine tool is also reduced.

Although the invention has been described in conjunction with some specific embodiments, it includes all technical equivalents of the means described.

1. A door to a machine tool, being positioned at a front of said machine tool on a workstation side of said machine tool, said door comprising:
a plurality of steps along an entire length thereof, a workstation being accessible when in a folded-down position and when not in operation; and
two actuators, activating opening and closing by operation of a lifting cable.

2. The door as claimed in claim 1, further comprising:
two bearings fixedly mounted to said machine tool.

3. The door as claimed in claim 1, wherein said two actuators are comprised of actuator rods, said actuator rods having a position monitored by a device.

4. The door as claimed in claim 1, further comprising:
a rubber strip on an exterior face thereof, contacting ground in an open position.

5. The door as claimed in claim 1, wherein said steps are comprised of glass-fiber-reinforced polyester.

6. The door as claimed in claim 1, wherein said steps are equipped with a non-slip device.

7. The door as claimed in claim 1, wherein opening and closing thereof are determined by whether or not said steps are in operation.
